(19) United States
(12) Patent Application Publication
(10) Pub. No.: US 2003/0077034 A1
(43) Pub. Date: Apr. 24, 2003

(54) Optical fiber, method of rotation-positioning the same and method of working the same

(76) Inventors: Norio Chiba, Chiba-shi (JP); Yoko Shinohara, Chiba-shi (JP); Yasuyuki Mitsuoka, Chiba-shi (JP); Hidetaka Maeda, Chiba-shi (JP); Kenji Kato, Chiba-shi (JP); Takashi Niwa, Chiba-shi (JP); Norihiro Dejima, Chiba-shi (JP); Susumu Ichihara, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/278,205

(22) Filed: Oct. 22, 2002

(30) Foreign Application Priority Data
Oct. 23, 2001 (JP) 2001-325229
Sep. 11, 2002 (JP) 2002-265711

(51) Int. Cl. G02B 6/26; G02B 6/16; G02B 6/38

(52) U.S. Cl. 385/31; 385/123; 385/55; 385/50

(57) ABSTRACT

When constituting an optical device using an optical fiber having end face slanted with respect to a vertical plane of a core axis, the optical fiber is simply rotation-positioned such that a direction of the end face becomes constant, thereby inexpensively producing the optical device and realizing a miniaturization of the optical device. In the optical fiber having the end face formed at an angle slanted with respect to a plane perpendicular to a core, a plane structure or a concave structure is formed in the optical fiber itself at a predetermined position with respect to a slant direction of the end face, or a holding structure is provided in the optical fiber.

### BACKGROUND OF THE INVENTION

1. Field or the Invention:

The present invention relates to a structure of optical fiber having an end face formed slantingly with respect to a plane perpendicular to a center axis of core, a method of rotation-positioning the optical fiber with respect to a direction of the end face, and a method of working the optical fiber.

2. Description of the Related Art:

Under the background of a rapid increase in data communication, needs for forming an optical communication network are enhanced. A conventional optical communication network is referred to as Point-to-Point, and has been one whose purpose is a long distant and large capacity data communication using the optical fiber only in transmission lines. In such an optical communication network, there is performed a processing in which an optical signal is once converted into an electric signal, a switching is carried out by using the electric signal,and thereafter the electric signal is converted into the optical signal again. Further, in order that the processing can be easily carried out by the electric circuit, the high speed optical signal is converted into a low speed. For this reason, there has been a problem that a processing speed is low and an apparatus itself constituting the network is expensive and large scale.

Therefore, in order to perform a large capacity and highly reliable communication by the whole network, the communication is being transferred to a system for transmitting the data to the whole communication network only by a light referred to as All-Optical.

As one of optical devices necessary for a network system transference from the Point-to-Point to All-Optical, there is an optical switch. The optical switch is one in which a selection of the data transmission path is performed by the light per sewithout converting the optical signal into the electric signal. At present, as optical switch devices developed or proposed, there are, for example, a system in which the path is switched by means of causing the light to transmit/reflect by using a micro mirror device, a system in which an optical fiber itself is moved, a system in which the path is switched by means of changing a refractive index by using a thermal, optical effect on a light waveguide line, and the like.

By using such an optical switch in the network, the data can be transmitted as the light per se without being converted into the electric signal but, on the other side, there is generated a light which retrogrades a communication path of the light. That is, the reflection occurs in a connecting face between the optical switch and the optical fiber which is the transmission line, the waveguide line in the optical switch, or an interface of the optical fiber end face, etc., and its reflected light retrogrades the path. If a quantity of such a retrograding light becomes large, there has been a problem that it becomes difficult to obtain a high stability of the whole network. For this reason, by giving a slant in the order of 4-8° to the optical fiber end face, the reflected light at the end face is prevented from entering again the core of optical fiber, thereby reducing a reflection loss as small as possible. The reflection loss means a ratio between the light emitting or propagating from the optical fiber end face and the light reflected at the optical fiber end face and returning in a reverse direction. For example, in case where the slant of 8° is given to the optical fiber end face, the reflection loss becomes −6° dB or less. By making the optical fiber end face into such a structure, it is realized to reduce the reflection loss in the transmission line.

In order to mutually connect the optical fiber end faces to each of which the slant has been given, it is necessary to precisely position the optical fibers such that the slant faces become mutually parallel. If the optical fibers are connected without being precisely positioned, (1) a gap is generated between the cores, (2) if the gap is generated between the cores, since the light emitting from the optical fiber end face is refracted at the slanted end face, the light does not advance on the same line as the core, and an irradiation position deviates with respect to the core of the incident side optical fiber. For this reason, the loss at the connected portion becomes extremely large. Therefore,when connecting the optical fibers, it becomes necessary to perform a working for parallelism and positioning a rotation direction of the optical fibers while confirming a quantity of propagated light. However,this method is not suitable for mass production and, further, an individual difference in connecting efficiency occurs. For this reason, in the optical fiber, etc. used in the transmission path there is provided, in a connector, a structure for defining the direction of the slant face. By this,since the end faces become parallel and are brought into contact with each other, the very small connection loss is realized.

In order to reduce the reflection loss in the whole communication network, it is necessary to slantingly form also the optical fiber end face provided in the optical device such as optical switch. Between the optical fiber end faces in the optical device, it is general that a constant distance gap is provided for disposing optical parts. Since the light emitting from the end face is refracted,a deviation between an irradiation position and an extension line of the emitting side core becomes large as the gap becomes large. Since a direction along which the irradiation position deviates is determined by a direction of the emitting side end face, if the optical fibers are connected without defining the direction of the end face, it is necessary to perform a positioning of the incident side optical fiber by two axes perpendicular to the center axis of the core. For this reason, since a precise positioning and adjusting work becomes necessary for every one optical fiber, the optical fibers cannot be mass-produced, so that there has been a problem that a manufacturing cost of the optical device increases.

Additionally, since such an optical device performs a light propagation in both directions, there is adopted such a constitution that the light propagates even if the emitting side end face is replaced with the incident side end face. Therefor, it is necessary that the optical paths in both directions coincide, i.e., the end faces of the emitting side and the incident side are disposed parallel to each other. However, since the slant angle of the end face is small, if there is adopted a method in which the device is actually mounted after adjusting the rotation while individually observing or image-recognizing, there has been a problem that the manufacturing cost of the device increases and the mass production is impossible.

### SUMMARY OF THE INVENTION

Therefore, the 1st invention is an optical fiber having an end face formed with a slanted angle with respect to a plane perpendicular to a center line of a core, wherein a plane structure having at least one plane is formed in the optical fiber itself.

Further, the 2nd invention is an optical fiber having an end face formed with a slanted angle with respect to a plane perpendicular to a center line of a core, wherein a concave structure is formed in the optical fiber itself.

Further, the 3rd invention is an optical fiber, wherein the plane structure or the concave structure is constituted by at least one plane including a straight line approximately parallel to the center axis of the core of the optical fiber.

Further, the 4th invention is an optical fiber having an end face formed with a slanted angle with respect to a plane perpendicular to a center line of a core, wherein there is provided a holding structure fixed to the optical fiber or a coating covering the optical fiber and having a plane including a straight line approximately parallel to at least the center line of the core.

Further, the 5th invention is an optical fiber, wherein the plane of the plane structure or the concave structure or the holding structure is provided at a position becoming a predetermined direction with respect to a slant direction of the end face.

Further, the 6th invention is two optical fibers, each of which has an end face formed with a slanted angle with respect to a plane perpendicular to a center line of a core, and in each of which there is formed the plane structure or the concave structure or to which the holding structure is attached, wherein the two optical fibers are manufactured from one optical fiber material in which a straight line parallel to the center axis of the core is supposed on an outside face, and the supposed straight line is disposed on an approximately one straight line in case where the end faces of the two optical fibers are parallel disposed while being mutually faced.

Further, the 7th invention is two optical fibers, each of which has an end face formed with a slanted angle with respect to a plane perpendicular to a center line of a core, and in each of which there is formed the plane structure or the concave structure or to each of which the holding structure is attached, wherein a position of the plane structure or the concave structure or the holding structure with respect to a direction of the slant of the end face observed from on an extension line of the center line of the core is disposed in an approximately 180 degrees point symmetry about the center axis of the core at the 1st optical fiber and the 2nd optical fiber.

Accordingly, since a direction of the end face can be discriminated from the position of the plane structure, the direction of the end face can be discriminated more simply than discriminating the direction of the end face itself. For this reason, it becomes possible to manufacture an optical device using the optical fiber in large quantity and inexpensively. Additionally, in case where the plane structure is provided in the optical fiber itself, a miniaturization is easy, and a manufacturing cost can be made inexpensive because no additional parts are required. Further, since it is possible to cut one optical fiber and parallel dispose the end faces at their postures intact, a displacement owing to an individual difference of core axis can be eliminated, so that a stable manufacturing becomes possible.

Further, the 8th invention is a method of rotation-positioning the optical fiber, including a procedure of performing a rotation-positioning by pushing a plane of the plane structure or the holding structure to a plate held at a predetermined position.

Further, the 9th invention is a method of rotation-positioning the optical fiber, including a procedure of performing a rotation-positioning by meshing the concave structure with a key structure held at a predetermined position.

Further, the 10th invention is a method of rotation-positioning the optical fiber, including a procedure of positioning the end face to a predetermined direction by means of controlling a rotation angle of the optical fiber about the center axis of the core by observing a position of the plane structure or the concave structure or the holding structure.

Accordingly, a direction of the end face can be mechanically rotation-positioned by pushing the flat plate to the plate structure or meshing the concave structure with the key structure. Further, by observing the plane structure and the like, since the direction of the end face can be discriminated more easily than observing the direction itself of the end face, the direction of the end face can be simply rotation-positioned. For this reason, it becomes possible to rotation-position the end face easily and at a high speed, so that it becomes possible to produce an optical device inexpensively and in large quantity.

Further, the 11th invention is a method of working the optical fiber, including procedures of fixing the optical fiber by a working jig, working the end face of the optical fiber and the plane structure or the concave structure, and detaching the optical fiber from the working jig.

Further, the 12th invention is a method of working the optical fiber, including procedures of attaching the holding structure to the optical fiber or a coating covering the optical fiber, fixing the optical fiber to a working jig together with the holding structure, working the end face of the optical fiber, and detaching only the working jig.

Further, the 13th invention is a method of working the optical fiber, including procedures of working a groove shape to the optical fiber approximately parallel to the center axis of the core, and cutting the groove shape portion of the optical fiber with a predetermined angle with respect to a plane perpendicular to the center axis of the core.

Further, the 14th invention is a method of working the optical fiber, wherein the plane structure or the concave structure is worked to the optical fiber or the two holding structures are attached to the same, and thereafter the plane structure portion or the concave structure portion or between the two holding structures is cut in a predetermined direction and with a predetermined angle or, after the cutting, the end face is polished in a predetermined direction with a predetermined angle.

Accordingly, since the optical fiber is fixed and held by the working jig, the optical fiber can be worked without rotating, and the plane structure and the like can be produced or attached with a high positional precision with respect to the direction of the end face. For this reason, the optical fiber can be produced simply, inexpensively and with a high precision. Further, since it is also possible to work the optical fiber while being held by the holding structure intact, the direction of the end face can be discriminated by the holding structure even if the optical fiber is taken out from the working jig, so that a simple positioning becomes possible. Further, since the two end faces can be formed from one optical fiber, a high speed and mass production becomes possible.

Further, the 15th invention is a method of working the optical fiber, including procedures of cutting the optical fiber with a predetermined angle with respect to a plane perpendicular to the center axis of the core or, after the cutting, polishing the end face with a predetermined angle with respect to a plane perpendicular to the center axis of the core, and thereafter working the plane structure or the concave structure to a predetermined position with respect to a slant direction of the end face or attaching the holding structure.

Accordingly, a slant of desired angle can be easily formed in the end face and, further, the plane structure and the like can be produced or attached with a high precision with respect to the direction of the end face. For this reason, the optical fiber can be produced easily, inexpensively and with a high precision.

Further, the 16th invention is a method of working the optical fiber, including procedures of performing a rotation-positioning by pushing a plane of the plane structure or the holding structure preliminarily formed to a plane structure held in a predetermined position, and cutting the end face in a predetermined slant direction with respect to a positioned rotation position of the optical fiber and with a predetermined angle with respect to a plane perpendicular to the center axis of the core or polishing it after the cutting.

Further, the 17th invention is a method of working the optical fiber, including procedures of performing a rotation-positioning by meshing the concave structure preliminarily formed with a key structure held in a predetermined position, and cutting the end face in a predetermined slant direction with respect to a positioned rotation position of the optical fiber and with a predetermined angle with respect to a plane perpendicular to the center axis of the core or polishing it after the cutting.

Further, the 18th invention is a method of working the optical fiber, including procedures of controlling a rotation angle of the optical fiber about the center axis of the core by observing a position of the plane structure or the concave structure or the holding structure preliminarily formed, rotation-positioning the end face in a predetermined direction, and cutting the end face in a predetermined slant direction with respect to a positioned rotation position of the optical fiber and with a predetermined angle with respect to a plane perpendicular to the center axis of the core or polishing it after the cutting.

Accordingly, the optical fiber can be worked without rotating, and the slant direction and the slant angle of the end face with respect to a position of the plane structure and the like can be produced with a high precision. For this reason, the optical fiber can be produced simply, inexpensively and with a high precision. Further, since it is also possible to work the optical fiber while being held by the holding structure intact, the direction of the end face can be discriminated by the holding structure, so that a simple positioning becomes possible.

### BRIEF DESCRIPTION OF THE DRAWINGS

FIG. 1A and FIG. 1B are constitutional views of an optical fiber according to an embodiment 1 of the invention.

FIG. 2A and FIG. 2B are views for explaining a method of rotation-positioning the optical fiber according to the embodiment 1 of the invention.

FIG. 3A and FIG. 3B are constitutional views of the optical fiber according to the embodiment 1 of the invention.

FIG. 4A, FIG. 4B and FIG. 4C are constitutional views of working jigs used in working the optical fiber according to the embodiment 1 of the invention.

FIG. 5 is an explanatory view showing a method of working the optical fiber according to the embodiment 1 of the invention.

FIG. 6A and FIG. 6B are constitutional views of the optical fiber according to an embodiment 2 of the invention.

FIG. 7A and FIG. 7B are constitutional views of the optical fiber according to an embodiment 3 of the invention.

FIG. 8A and FIG. 8A are constitutional views of the optical fiber according to an embodiment 4 of the invention.

FIG. 9A and FIG. 9B are explanatory views showing the method of working the optical fiber according to the embodiment 4 of the invention.

FIG. 10A, FIG. 10B and FIG. 10C are constitutional views of the optical fiber according to an embodiment 5 of the invention.

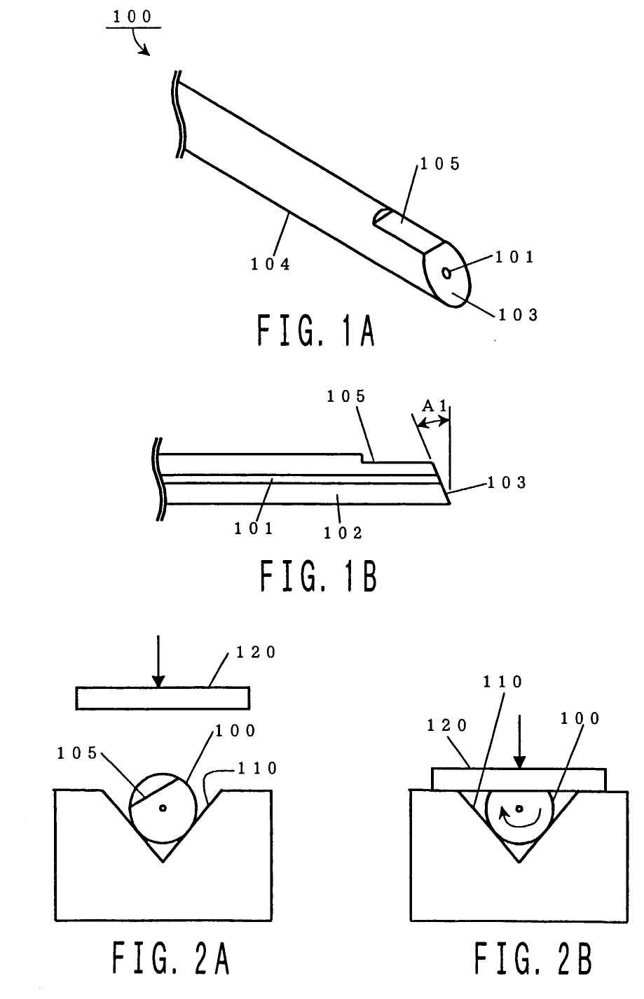

FIG. 1A and FIG. 1B are constitutional views of working jigs used in working the optical fiber according to the embodiment 5 of the invention.

FIG. 12 is a constitutional view of the optical fiber according to the embodiment 5 of the invention.

### DESCRIPTION OF THE PREFERRED EMBODIMENTS

Hereunder, it is explained about an optical fiber of the invention and a method of rotation-positioning the optical fiber with the attached drawings being referred. Incidentally, the invention is not limited by embodiments mentioned below.

(Embodiment 1)

(Structure)

In FIG. 1A and FIG. 1B, an optical fiber 100 according to the embodiment 1 is shown. FIG. 1A is a perspective view of the optical fiber 100 and FIG. 1B a sectional view obtained by cutting a plane containing a center of core of the optical fiber 100. An end face 103 of the optical fiber 100 is slanted at an angle Al with respect to a plane perpendicular to an axis of the core 101. Additionally, between the end face 103 and an outside face 104 of the optical fiber 100, a plane structure 105 is provided. Incidentally, the plane structure 105 is provided with a position in which an angle defined by the end face 103 and the outside face 104 becomes the most obtuse angle being made a center.

Incidentally, the slant angle A1 is in the order of several to 20 or 30 degrees. If a communication system single mode optical fiber for wavelength 1550 nm for instance is used, a diameter of the optical fiber 100 becomes 125 μm and that of the core 101 about 10 μm. In order not to hinder an optical transfer of the core 101, if the plane structure 105 is formed by removing the cladding of the optical fiber 100 in the order of, for example, 0.5 mm in length, 0.1 mm in width and 30 μm in the maximum depth, the plane structure 105 becomes a mark in the order capable of being viewed. Further, as the optical fiber 100, a multi mode optical fiber of step index type or refractive index distributing type can be used besides the above-mentioned single mode optical fiber.

(Rotation-Positioning Method)

As to a method of rotation-positioning the optical fiber 100, it is shown in FIG. 2A and FIG. 2B. The optical fiber 100 is placed in a V-groove 110. On this occasion, since the plane structure 105 defining the direction of the optical fiber end face 103 can be viewed, the optical fiber 100 is placed such that it becomes roughly above the V-groove 110. Here, if a flat-plate-like pushing key 120 is pushed from above, the pushing key 120 is brought into contact with the plane structure 105. The optical fiber 100 is rotated in the V-groove 110 such that a face of the plane structure 105 agrees with a surface of the pushing key 120, so that an upper face of the V-groove, the pushing key 120 and the plane structure 105 are disposed on one plane. Since the direction of the end face 103 of the optical fiber 100 is constant with respect to a position of the plane structure 105, it becomes possible to simply rotation-position the direction of the end face 103 by means of positioning the plane structure 105 by the pushing key 120. Incidentally, a method of rotation-positioning the optical fiber by means of observing the position of the plane structure 105 by a microscope and the like is possible as well.

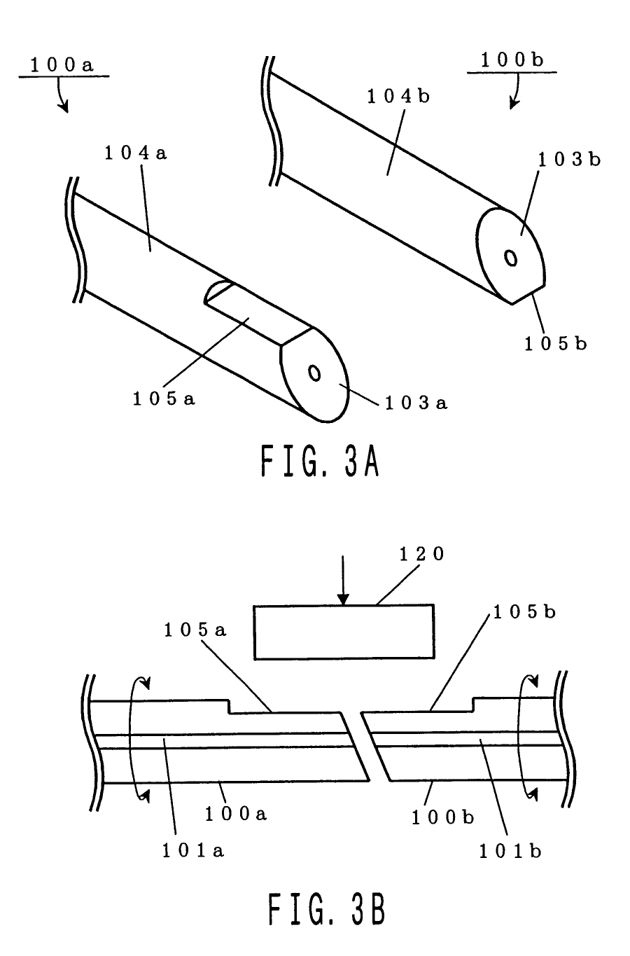

Additionally, in FIG. 3A and FIG. 3B, there is shown a method of mutually, parallel position-rotating the two optical fibers 100a, 100b whose end faces are provided slantingly with respect to the plane perpendicular to the center axis of the core. The two optical fibers 100a, 100b are respectively provided with the plane structures 105a, 105b. However, the plane structures 105a, 105b with respect to the directions of the slants of the end faces 103a, 103b are provided so as to mutually become positions of 180° point symmetry with the cores 101a, 101b being respectively made centers when respectively viewed from on extension lines of the cores 101a, 101b. That is, in the optical fiber 100a, the plane structure 105a is provided at a position in which an angle defined by the end face 103a and the outside face 104a becomes the most obtuse angle, and the plane structure 105b at a position in which an angle defined by the end face 103b and the outside face 104b of the optical fiber 100b becomes the most acute angle. Here, in FIG. 3A, if the flat-plate-like pushing key 120 is pushed to the optical fibers 100a, 100b, in the V-groove (omitted in the drawings) the optical fibers 100a, 100b are rotated with the cores 101a, 101b being made axes, and both the end faces 103a, 103b can be positioned so as to become parallel. Additionally, if the optical fibers 100a, 100b are pushed also in an axial direction of the core and pushed by the pushing key 120 by means of respectively defining lengths of the plane structures 105a, 105b with respect to the axial directions of the cores 101a, 101b and a length of the pushing key 120, it becomes possible to adjust a distance between the end faces 103a, 103b to a constant value.

Incidentally, when observed from the extension line of the center axis of the core, the plane structures 105a, 105b can be provided at optional positions so long as positions of the plane structures 105a, 105b with respect to the directions of the slants of the end faces 103a, 103b meet a condition that they are mutually in the 180° point symmetry with the cores 101a, 101b being made centers.

Additionally, in case where the optical fibers 100a and 100b are faced with a predetermined distance being maintained, or in case where the optical fibers 100a and 100b are faced through a mirror (not shown) with the predetermined distance being maintained, it is possible to perform the rotation-positioning by respectively, independently pushing the pushing key 120 to the plane structures 105a, 105b. On this occasion, it is necessary that a guide face of the pushing key 120 exists on the same plane. Further, it is necessary that the V-groove 110 or its mirror image is disposed on an approximately collinear line.

(Working Method)

As to a producing method of the optical fiber 100, it is possible to use a polishing, a chemical removing work (etching), a chemical polishing, a cleaving work using a cleaving apparatus, and the like. Incidentally,at present,in case where an optical fiber connector is produced, since it is general that the end face of the optical fiber inserted into a ferrule is polished together with the ferrule to a spherical shape, here it is shown about a method of producing the end face and the plane structure of the optical fiber by the polishing.

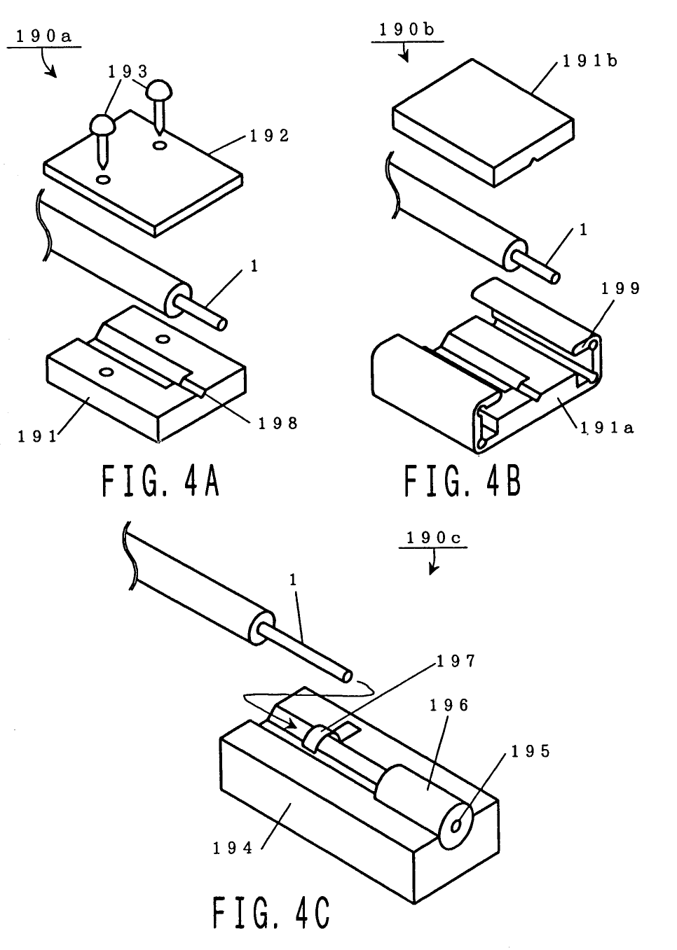

First, in FIG. 4A to FIG. 4C it is shown about a working jig 190 for fixing the optical fiber when it is worked. The working jig 190a shown in FIG. 4A comprises a V-groove base plate 191 and a planar base plate 192, and has a structure in which the V-groove base plate 191 and the planar base plate 192 are jointed by screws 193. An optical fiber cord 1 which is a material is sandwiched between the V-groove base plate 191 and the planar base plate 192. The optical fiber cord 1 is one in which the optical fiber consisting of a core and a clad is covered by a coating, and the coating is removed in the vicinity of the end face of the optical fiber. If jointed by the screws 193, a coating portion of the optical fiber cord 1 occurs a plastic deformation between the V-groove base plate 191 and the planar base plate 192, and the optical fiber cord 1 is fixed and supported. Additionally, by highly, precisely forming a V-groove 198 in the vicinity of a tip, it is also possible to be fixed only by an optical fiber portion of the optical fiber cord 1 not by a fixing at the coating portion. Incidentally, a tip of the optical fiber is fixed protruding from ends of the V-groove base plate 191 and the planar base plate 192 by about several hundreds μm to several mm. Further, in order to increase a rotational resistance of the optical fiber cord 1 after being fixed, it may be supported by providing a thin elastic body such as rubber between the optical fiber cord 1 and the planar base plate 192 or between the optical fiber cord 1 and the V-groove base plate 191.

Further, like FIG. 4B, it is also possible to constitute the working jig 190b only by V-groove base plates 191a, 191b without using the screws. The optical fibercord 1 is sandwiched by V-grooves of the V-groove base plates 191a, 191b. There is adopted a structure in which a spring structure 199 formed in both ends of the V-groove base plate 191a presses down the V-groove base plate 191b while sandwiching the optical fiber cord 1. For this reason it is possible to fix and support the optical fiber cord 1 sandwiched between the V-groove base plates 191a and 191b. Incidentally, the optical fiber tip is fixed while protruding from ends of the V-groove base plates 191a, 191b by about several hundreds μm to several mm. Further, the spring structure 199 can be worked by a press and the like.

Further, as shown in FIG. 4C, it is also possible to constitute the working jig 190c in which there is provided a bore for passing only an optical fiber portion of the optical fiber cord 1 as in the ferrule. The working jig 190c comprises a base plate 194, an optical fiber holding portion 196 provided with a fine bore 195, and a coating portion pusher 197. The optical fiber holding portion 196 is fixed to the base plate 194, and the coating portion pusher 197 is also provided on the base plate 194. The optical fiber portion of the optical fiber cord 1 is inserted into the fine bore 195 of the optical fiber holding portion 196, and the coating portion of the optical fiber cord 1 is fixed so as not to rotate by the coating portion pusher 197. For this reason, since a vicinity of the tip of the optical fiber cord 1 is fixed by the fine bore 195 and the coating portion pusher 197 prevents the optical fiber cord 1 from rotating, it is possible to hold a displacement and the rotation at the optical fiber tip to very small degrees. Incidentally, the fine bore 195 is worked with a very high precision for an optical fiber outer diameter of the optical fiber cord 1, and an inner diameter of the fine bore 195 is in the order of several μm larger than the optical fiber outer diameter. Further, the tip of the optical fiber is fixed while protruding from an end of the optical fiber holding portion 196 by about several hundreds μm to several mm.

Next, in FIG. 5 it is shown about a method of working the optical fiber. Here, a rotary polishing machine 180 is used for working the optical fiber. When polishing, the working jig 190 to which the optical fiber cord 1 has been attached is held so as not to move, and a working is performed by pushing the optical fiber tip of the optical fiber cord 1 under a predetermined pressure to a rotating grinding stone 181 of the polishing machine 180. For the grinding stone 181, there is used an abrasive paper of diamond abrasive grains whose grain size is in the order of several thousand number to ten thousands number for instance. Incidentally, a reference plane B is defined on the working jig 190 so as to become a reference when polishing. It is desirable that the reference plane B is parallel to the center axis of the core of the optical fiber cord 1.

First, it is explained about a working of the plane structure. The optical fiber of the optical fiber cord 1 is pushed to the grinding stone 181 such that the reference plane B of the working jig 190f and the grinding stone 181 become parallel. The optical fiber of the optical fiber cord 1 is polished, and the plane structure 105 parallel to the center axis of the core of the optical fiber cord 1 is formed. Next, it is explained about a working of the end face. The working jig 190e is held such that a plane perpendicular to the grinding stone 181 and the reference plane B of the working jig 190e define the angle A1, and it is pushed to the grinding stone 181. In case of FIG. 5, a slanting direction is such a direction that, at a position of the plane structure 105 formed before hand, an angle between the optical fiber end face and the outside face of the optical fiber cord 1 becomes the most obtuse angle. If polished in this manner, in the optical fiber tip of the optical fiber cord 1, there can be formed the end face 103 slanted by the angle A1 with respect to a plane becoming perpendicular to the center axis of the core. Incidentally, even if an order of forming the plane structure 105 and the end face 103 is reversed, the production is possible.

If the working jig 190 can be precisely held and pushed to the grinding stone 181 in this manner, it becomes possible to easily and highly, precisely work the optical fiber.

Additionally, the plane structure 105 is formed by attaching the two working jigs 190 to the optical fiber portion from which the coating of one optical fiber cord 1 has been removed and pushing the optical fiber cord 1 between the two working jigs 190 to the grinding stone 181 of the rotary polishing machine 180. Thereafter, the optical fiber cord 1 is cut at the portion where the plane structure 105 has been formed and, as mentioned before, each of cut faces is polished, thereby forming the end face 103. On this occasion, in the cut face of each optical fiber there is formed the end face 103 such that it is slanted by a predetermined angle with respect to a plane perpendicular to the core 101 and, additionally, a position of the plane structure 105 with respect to a direction of the slant face of the end face 103 observed from an extension line of the center axis of the core becomes the point symmetry of 180° with the core 101 being made a center. Further, it is also possible to replace the process in which the polishing work is performed after the cutting with a process in which the cleaving is performed so as to possess the cut face slanted at a predetermined angle with respect to the plane perpendicular to the core 101. Incidentally, a slant cleaving apparatus slantingly cutting with respect to the plane perpendicular to the center line of the core is marketed at present. In case of a cleaving process, since the position of the plane structure 105 with respect to the direction of the slant face of the end face 103 observed from the extension line of the center axis of the core necessarily becomes the point symmetry of 180° with the core 101 being made a center, there is an advantage that it is unnecessary to perform a rotation adjustment before forming the end face 103. In this manner, if the rotation positioning is performed such that the end faces of the optical fiber produced from one optical fiber become mutually parallel, the optical fiber end face and the plane structure can be stably and highly, precisely produced irrespective of the individual difference of the optical fiber, such as axial displacement of the core.

Further, it is also possible to form the plane structure 105 by the end face slanting work using the polishing or slant cleaving apparatus after preliminarily forming the end face 103 at an angle slanted by the predetermined angle with respect to the plane perpendicular to the core 101. On this occasion, a slant direction of the end face 103 can be confirmed by an observation. Especially, in case where the slant working of the end face 103 is performed by using the slant cleaving apparatus, a trace remains in a portion against which a teeth tool of the slant cleaving apparatus has hit. Since the slant direction of the end face 103 has a regularity with respect to the trace, it is possible to precisely determine a formation position of the plane structure 105 with the trace being made a mark.

Additionally, it is also possible to perform the slant working of the end face 103 by preliminarily forming the plane structure 105 and making the plane structure itself into the reference plane to perform the polishing and the slant cleaving work. That is, in case of the polishing, the plane structure 105 is used as the reference plane B shown in FIG. 5. Further, in case of the slant cleaving work, the position of the plane structure 105 is adjusted by the observation or, by establishing a plane becoming the reference also in an optical fiber establishing portion of the slant cleaving apparatus, the positioning of the rotation direction is performed by pushing the plane structure 105 to that reference plane.

By the above, since the optical fiber is rotation-positioned by pushing the pushing key to the plane structure or observing the position of the plane structure, the rotation-positioning can be performed more simply than rotation-positioning by observing the direction itself of the slant of the end face. Additionally, since the plane structure is provided in the optical fiber itself, a miniaturization is easy and no additional parts are necessary, so that a manufacturing cost can be made inexpensive. Further, since the mechanical rotation-positioning in which the flat plate is pushed to the plane structure can be performed, the rotation-positioning of the end face becomes possible easily and at a high speed. Further,the plane structure can be produced with a high positional precision with respect to the direction of the end face without rotating the optical fiber when being worked, so that the plane structure can be produced simply and with a high positional precision.

(Embodiment 2)

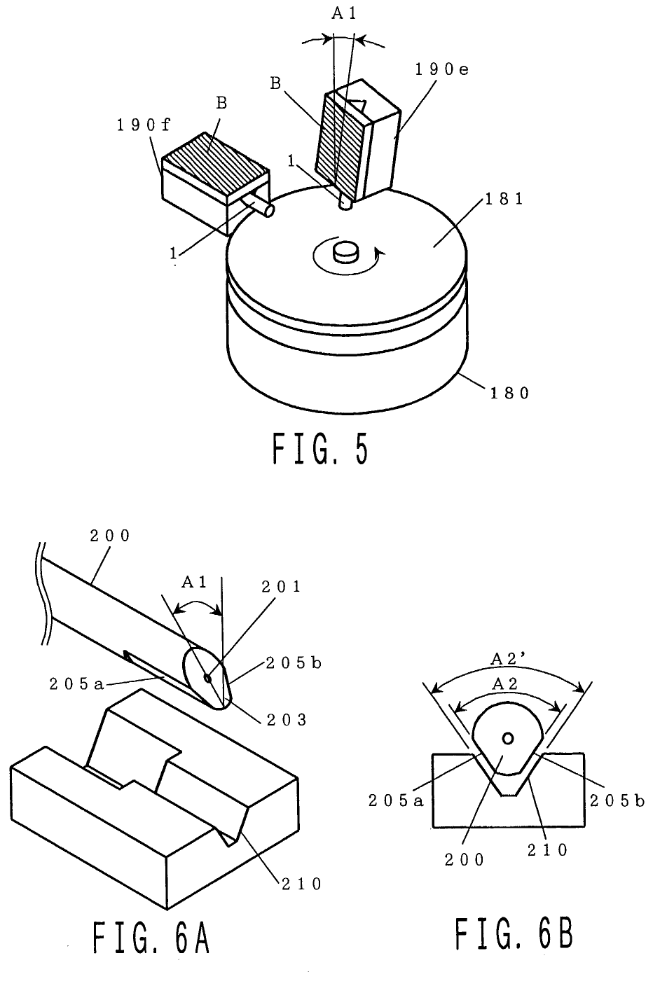

In FIG. 6A and FIG. 6B it is shown about an optical fiber 200 according to an embodiment 2 of the invention. Incidentally, as to matters similar to the embodiment 1, the explanations are omitted.

(Structure and Rotation-Positioning Method)

FIG. 6A is a perspective view of the optical fiber 200, and FIG. 6B a view obtained by observing the end face of the optical fiber 200 from the extension line of the center axis of the core of the optical fiber 200. The optical fiber 200 is provided with an end face 203 slanted by the angle Al with respect to a vertical plane of a core 201. Additionally, two plane structures 205a, 205b parallel to the core 201 are provided. Viewed form the extension line of the core 201, the plane structures 205a and 205b are formed while defining an angle A2. Further, slant faces of a V-groove 210 in which the optical fiber 200 is placed define an angle A2′. Here, since the angle A2′ is formed so as to be approximately equal to or somewhat smaller than the angle A2, if the optical fiber 200 is placed in the V-groove 210, the slant faces of the V-groove 210 are respectively opposed to both the plane structures 205a, 205b, and a posture of the optical fiber 200 becomes constant in the V-groove 210. For this reason, if positions of the plane structures 205A, 205b with respect to the direction of the end face 203 of the optical fiber 200 are determined, the end face 203 of the optical fiber 200 placed in the V-groove 210 becomes always a constant direction, so that it become possible to simply position the direction of the end face 203.

(Producing Method)

It is explained about a method of producing the optical fiber 200 by the producing method by means of polishing mentioned in the embodiment 1 of the invention. The polishing is performed by pushing the working jig 190 holding and fixing the optical fiber cord 1, in which the optical fiber consisting of the clad and the core is covered with the coating, to the grinding stone 181 of the rotary polishing machine 180. On this occasion, the working jig 190 is held by means of slanting the reference plane B of the working jig 190 by A2/2 about the center axis of the core of the optical fiber cord 1 from the parallel faces of the grinding stone 181. Keeping this posture intact, the polishing is performed by pushing the optical fiber cord 1 to the grinding stone 181. Thereafter, the polishing is similarly performed by slanting the reference plane B of the working jig 190 by the angle A2/2 about the center axis of the core from a parallel face of the grinding stone 181 in a reverse direction along which it has been slanted by the angle A2/2. By this it is possible to form the plane structures 205a, 205b each of whose relative positions defines the angle A. Next, similarly to the method of forming the end face in the embodiment 1 of the invention, the polishing is performed by holding the working jig 190 with it being slanted such that a vertical face of the grinding stone 181 and the reference plane B define the angle A1, and pushing it to the grinding stone 181. By the above processes, in the optical fiber tip of the optical fiber cord 1 there are formed the end face 203 slanted by the angle A1 with respect to the plane perpendicular to the center axis of the core,and the plane structures 205a, 205b. Incidentally, the production is possible even if the order of forming the plane structures 205a, 205b and the end face 203 is reversed. Further, similarly to the embodiment 1, the end face 203 can be formed also by the slant cleaving work.

By the above, since the direction of the end face is discriminated from the position of the plane structure, the discrimination can be performed more simply than discriminating the direction itself of the end face. Additionally, since the plane structure is provided in the optical fiber itself, the miniaturization is easy, and the manufacturing cost can be made inexpensive because no additional parts are required. Further, since the rotation-positioning can be performed only by the optical fiber and the V-groove which are placed, the number of parts is small and the rotation-positioning of the end face becomes possible easily and at a high speed.

(Embodiment 3)

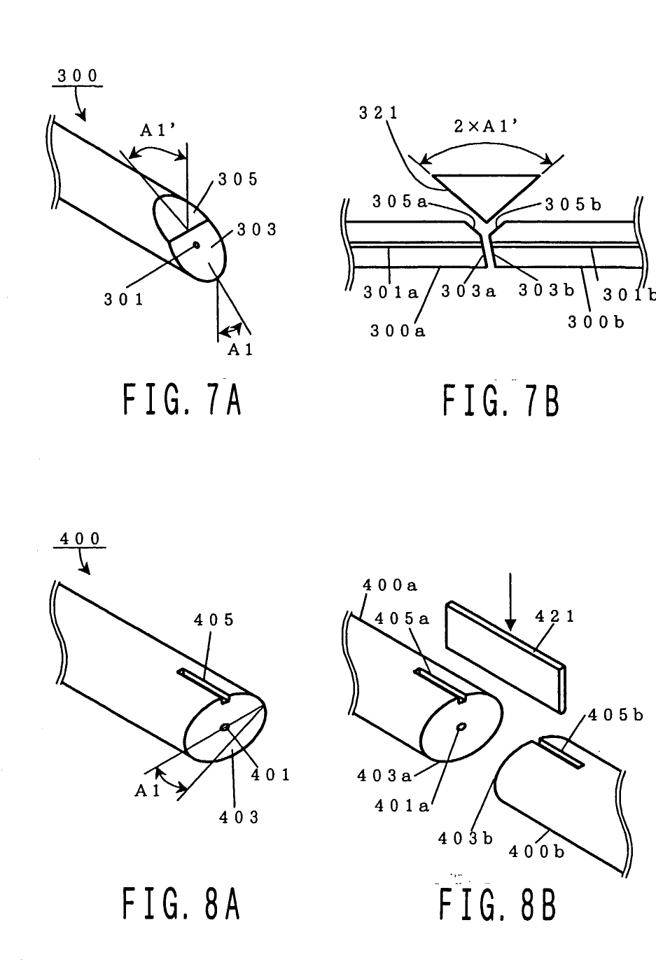

In FIG. 7A and FIG. 7B it is shown about an optical fiber 300 according to an embodiment 3 of the invention. Incidentally, as to matters similar to the embodiments 1 and 2, the explanations are omitted.

FIG. 7A is a perspective view of the optical fiber 300, and FIG. 7B is a sectional view obtained by means of cutting the optical fiber 300 by a plane containing a center of the core. The optical fiber 300 is provided with an end face 303 slanted by the angle A1 with respect to a vertical plane of the core 301. Additionally, in a clad portion of the end face 303, there is provided a plane structure 305 which is different from the end face 303 and provided at an angle A1′. On this occasion, the angle A1′ is made larger than the angle A1.

Here, as shown in FIG. 7B, the end faces 303a, 303b of the two optical fiber 300a, 300b are placed in the V-groove (not shown) while being mutually faced. Incidentally, positions of the plane structures 305a, 305b observed from an extension line of the core 301 become the 180° point symmetry with the core 301 being made a center with respect to the direction of the end face. Here, a wedge shape key structure 321 whose angle becomes 2×A1′is used. If the wedge key structure 321 is pushed to the plane structure 305, the optical fiber 300 is rotated in the V-groove with the cores 301a, 301b being made a center such that a surface of the key structure 321 is brought into a surface contact with the plane structure 305, so that the end faces 303a, 303b are positioned so as to become mutually parallel.

Incidentally, the plane structure 305 can be worked by the polishing method shown in the embodiment 1. That is, the plane structure 305 can be formed by separately performing the angle control so as to work the end face 303 of the optical fiber.

By the above, since the direction of the end face can be rotation-controlled by pushing the key structure to the plane structure, the discrimination can be performed more simply than discriminating the direction itself of the end face. Additionally, since the plane structure is provided in the optical fiber itself, the miniaturization is easy, and the manufacturing cost can be made inexpensive because no additional parts are required. Further, since a relative angle between the end face and the plane structure is small, the end face and the plane structure can be easily formed by the working whose angle control is slight.

(Embodiment 4)

In FIG. 8A and FIG. 8B it is shown about an optical fiber 400 according to an embodiment 4 of the invention. Incidentally, as to matters similar to the embodiments 1 to 3, the explanations are omitted.

(Structure)

FIG. 8A is a perspective view of an optical fiber 400, and FIG. 8B an explanatory view showing a method of parallel positioning the two optical fiber 400a, 400b. The optical fiber 400 is provided with an end face 403 slanted by the angle A1 with respect to the vertical plane of a core 401. Additionally, a groove-like concave structure 405 is provided in a clad portion of the end face 403. On this occasion, the concave structure 405 is provided at a position in which the end face 403 becomes a predetermined position.

(Positioning Method)

Here, as shown in FIG. 8B, each of positions of the concave structures 405a, 405b observed from an extension line of each of the cores 401a, 401b is placed in the V-groove (not shown) with the end faces 403a, 403b of the two optical fibers 400a, 400b having become the 180° point symmetry about the cores 401a, 401b with respect to the direction of a slant of the end face being mutually faced. Here, the optical fibers 400a, 400b are rotated with the cores 401a, 401b being made a center, and a key structure 421 pushed from above in FIG. 8B is meshed respectively with the concave structures 405a, 405b. When the key structure 421 is meshed with the concave structures 405a, 405b, the end faces 403a, 403b are positioned so as to mutually become parallel.

Further, similarly to the explanation about the embodiment 1, it is also possible that the optical fibers 400a and 400b are faced with a predetermined distance or the optical fibers 400a and 400b are faced through a mirror (not shown) with the predetermined distance.

(Producing Method)

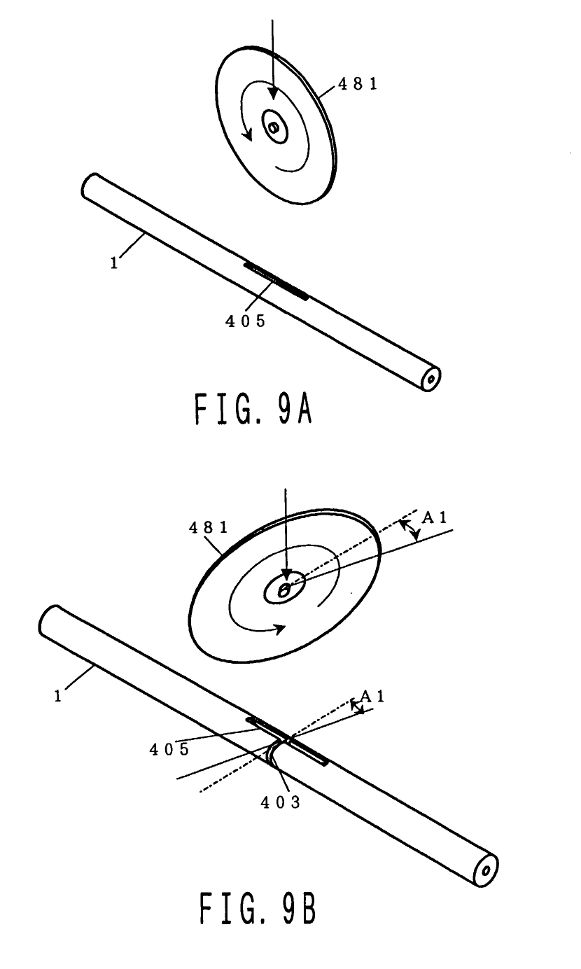

In FIG. 9A and 9B it is explained about a method of working an optical fiber 400. Here, a dicing saw is used for working the optical fiber 400.

The optical fiber cord 1 is fixed onto a base board (not shown) by using a wax and the like. First, in FIG. 9A it is shown about a process for forming a concave structure 405. The optical fiber cord 1 is worked by pushing a rotating dicing blade 481 by pushing it from above and parallel thereto. On this occasion, an optical fiber portion of the optical fiber cord 1 is not cut completely and only a groove-like working is applied to a clad portion of the optical fiber cord 1. For this reason, the concave structure 405 can be formed in an optical fiber core wire portion of the optical fiber cord 1.

Next, in FIG. 9B it is shown about a process for forming an end face 403. The base plate is placed such that a cutting direction of the dicing blade 481 is slanted by the angle A1 with respect to a vertical plane (dashed line in the drawing) of the center axis of the core of the optical fiber cord 1 by means of rotating the base plate. Here, the optical fiber cord 1 is cut by pushing the rotating dicing blade 481 to a vicinity of a groove's center of the optical fiber cord 1 worked in the previous process. If worked in this manner,there can be formed two optical fibers 400 in each of which the end face is slanted by the angle A1 with respect to a vertical plane of the center line of the core and the concave structure 405 is provided in the vicinity of the end face. Further, as to only the optical fiber portion in which the coating portion of the optical fiber cord 1 has been removed, it can be worked similarly. Incidentally, a diamond blade of several tens μm in thickness has been used for the dicing blade 481.

Further, the optical fiber 400 can be worked also by the polishing, working method shown in the embodiment 1. The end face of the optical fiber cord 1 is formed by pushing the working jig 190 holding and fixing the optical fiber cord 1 to the grinding stone 181 of the rotary grinding machine 180 while being slanted by a predetermined angle. Thereafter, the optical fiber 400 can be formed by pushing an edge, etc. of the grinding stone 181 to a vicinity of the end face of the optical fiber cord 1 to thereby form the concave structure 405. Incidentally, it is possible to perform the working by using in combination the dicing saw and the grinding machine in such a manner that, for example, the end face is formed by the dicing saw and the concave structure by the grinding machine.

Further, similarly to the embodiment 1, it is also possible to form the concave structure 405 after the end face 403 has been slantingly worked. Further, it is also possible to perform the polishing work or slant cleaving work of the end face 403 with the preliminarily worked concave structure 405 being made a reference.

By the above, since the direction of the end face can be positioned by pushing the key structure to the concave structure, the discrimination can be performed more simply than discriminating the direction itself of the end face. Further, since the plane structure is provided in the optical fiber itself, the miniaturization is easy, and the manufacturing cost can be made inexpensive because no additional parts are required. Additionally, since the two optical fibers are produced from one optical fiber, a dispersion at the working time can be eliminated without requiring a high working precision. And, since an axial displacement of the core owing to an individual difference in the optical fiber can be eliminated as well, it becomes possible to enhance a connecting efficiency.

(Embodiment 5)

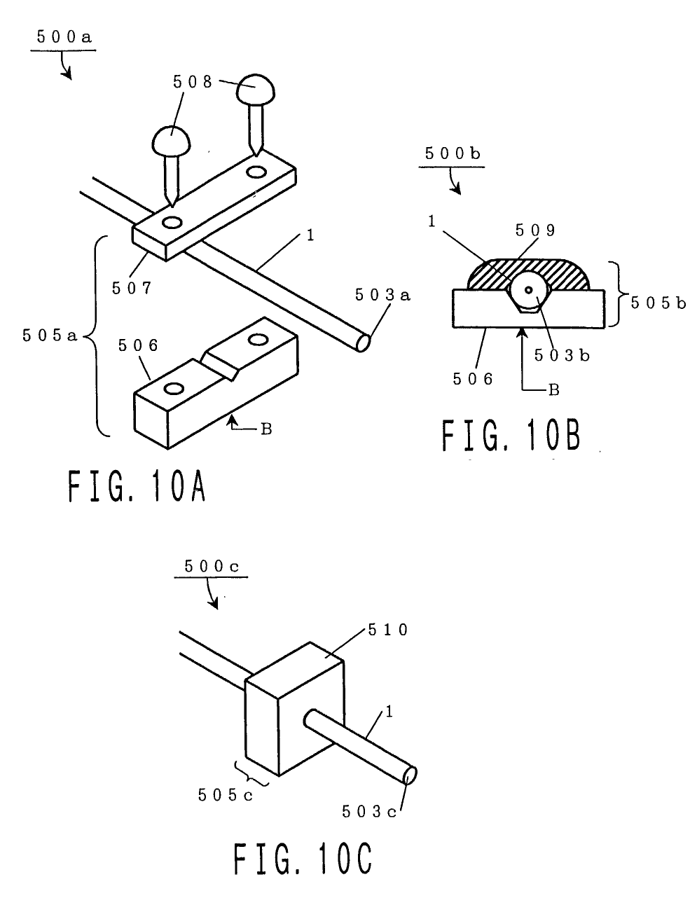

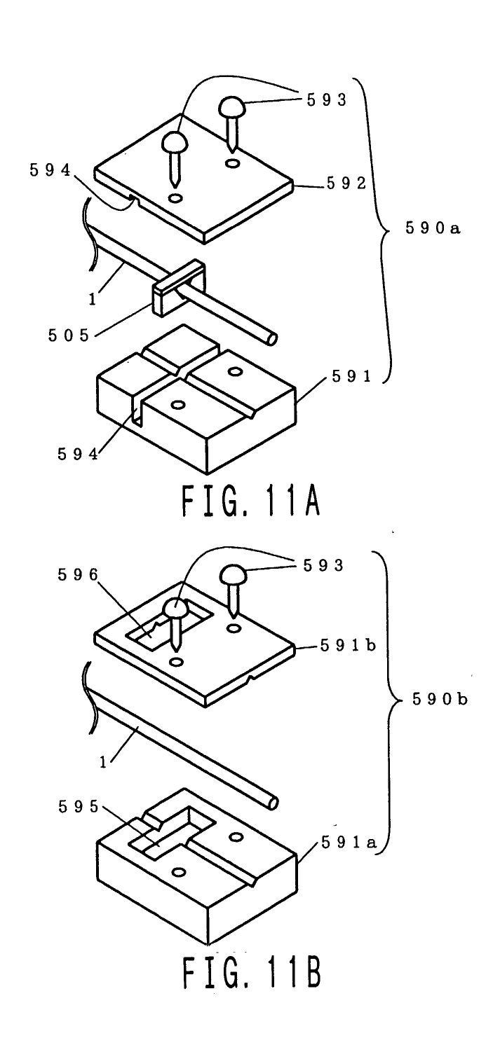

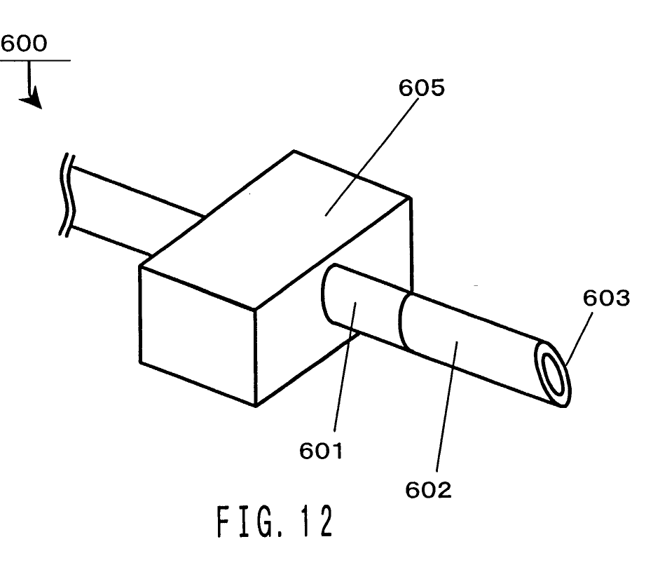

In FIG. 10A to FIG. 10C it is shown about an optical fiber 500 according to an embodiment 5 of the invention. Incidentally, as to matters similar to the embodiments 1 to 4, the explanations are omitted.

(Structure and Positioning Method)

FIG. 10A is a perspective view of the optical fiber 500a, FIG. 10B an explanatory view obtained by observing the end face from the extension of the center axis of the core of the optical fiber 500b, and FIG. 10C a perspective view of the optical fiber 500c. In the optical fibers 500a, 500b, 500c, there are formed end faces 503a, 503b, 503c each of which is slanted by the angle A1 with respect to a vertical plane of the center axis of the core. Additionally, in the vicinity of the end faces 503a, 503b, 503c, there are respectively attached holding structures 505a, 505b, 505c. Incidentally, the reference plane B is respectively defined in the holding structures 505a, 505b, 505c, and the holding structure 505 is attached such that directions of the reference plane and the end face 503 become a predetermined relative, positional relation.

Next, it is respectively explained about structures of the holding structures 505a, 505b, 505c.

In the holding structure 505a of FIG. 10, there is adopted a structure in which the optical fiber cord 1 is sandwiched by a V-groove part 506 and a flat plate 507, the V-groove 506 part and the flat plate 507 are jointed by screws 508, and thus the optical fiber cord 1 is fixed.

In the holding structure 505b of FIG. 10B, there is adopted a structure in which the optical fiber cord 1 placed in the V-groove part 506 is fixed by an adhesive 509.

In the holding structure 505c of FIG. 10C, there is adopted a structure in which the whole optical fiber cord 1 is molded by a resin 510 and the like.

As the optical fiber cord 1, in addition to a single mode optical fiber and a multi-mode optical fiber, it is also possible to use a collimated optical fiber in which a refractive index distributing optical fiber is attached to a tip of the single mode optical fiber and which has a conversing effect.

FIG. 12 is a perspective view of a collimated optical fiber 600. The collimated optical fiber 600 has a constitution in which a refractive index distributing optical fiber 602 of predetermined length is disposed to a tip of a single mode optical fiber 601. In a tip portion of there fractive index distributing optical fiber 602, there is formed an end face 603 slanted by the angle A1 with respect to a vertical plane of the center axis of the core. Additionally, in a single mode optical fiber 601 portion, there is attached a holding structure 605. Incidentally, as the holding structure 605, any of the holding structures 505a, 505b, 505c mentioned above can be used. The refractive index distributing optical fiber 602 is connected to the single mode optical fiber 601 by a fusion connection or bonding for instance. As to the converging effect of the collimated optical fiber 600, the desired converging effect can be obtained by setting a length of the refractive index distributing optical fiber 602 to a predetermined length. In the collimated optical fiber 600, since the refractive index distributing optical fiber 602 having a large core diameter is used,the embodiment 5 is especially effective from a viewpoint that no removing work is applied to the optical fiber itself. However, if a working size is adjusted, this can be implemented for the embodiments 1 to 4.

(Positioning Method)

In order to position the end face 503 of the optical fiber 500, the reference plane B of the holding structure 505 is used. The reference plane B of the holding structure 505 is discriminated, and the whole optical fiber 500 is fixed such that the reference plane B becomes a predetermined posture. Since the end face 503 takes a constant direction with respect to the reference plane B, it becomes possible to position the end face 503 easily and to an optional direction by positioning the reference plane B.

(Working Method)

The optical fiber 500 can be worked basically by the polishing method shown in the embodiment 1 of the invention. However, since the optical fiber 500 is fixed by the working jig together with the holding structure 505, it is necessary to somewhat change a structure of the working jig.

A structure of that working jig 590 is shown in FIG. 11A and FIG. 11B. Both of FIG. 11A and FIG. 11B are perspective views showing structures of the working jigs 590a, 590b.

First, it is explained about the working jig 590a shown in FIG. 11A. The working jig 590a comprises a V-groove base plate 591 and a flat base plate 592, and has a constitution in which the optical fiber cord 1 is sandwiched by the V-groove base plate 591 and the flat base plate 592 which are jointed by screws 593. Additionally, in order to fix the optical fiber cord 1 together with the holding structure 505, escape grooves 594 are provided in the V-groove base plate 591 and the flat base plate 592. For this reason, it becomes possible to sandwich and fix an optical fiber portion of the optical fiber cord 1 to which the holding structure 505 is mounted by the V-groove base plate 591 and the flat base plate 592.

Next, it is explained about the working jig 590b shown in FIG. 11B. The working jig 590b comprises two V-groove base plates 591a, 591b, and has a constitution in which the optical fiber cord 1 is sandwiched by the V-groove base plates 591a, 591bwhich are jointed by the screws 593. Additionally, a groove 595 is provided in the V-groove base plate 591a, and a through-hole 596 in the V-groove base plate 591b. Only the optical fiber cord 1 is fixed by the V-groove base plates 591a, 591b, and the end face of the optical fiber cord 1 is subjected to the polishing work. And, a resin is poured from the through-hole 596 and the resin is cured. Thereafter, the optical fiber cord 1 is detached from the working jig 590b, and a production of the optical fiber 500 to which the holding structure 505 made of the resin has been attached is completed. Incidentally, even if the order of the end face working of the optical fiber cord 1 and the formation of the holding structure 505 is reverse, it is possible to produce the optical fiber 500.

By the above, since the direction of the end face can be discriminated from the reference plane by attaching the plane structure in which the reference plane has been provided to the optical fiber, the discrimination can be performed more simply than discriminating the direction itself of the end face. Additionally, since the plane structure is simply attached to the optical fiber, it can be produced in large quantity and inexpensively. Further,since the optical fiber is not rotated when worked, the plane structure can be produced with respect to the direction of the end face with a high positional precision, so that the plane structure can be produced simply and with a high precision.

As explained in the above, according to the invention, since the optical fiber is rotation-adjusted by observing the plane structure, the concave structure or holding structure provided in the optical fiber, the direction of the end face can be positioned more simply than performing the rotation-positioning by observing the direction itself of the end face. For this reason, it becomes possible to manufacture an optical device using the optical fiber in large quantity and inexpensively. Additionally, in case where the plane structure is provided in the optical fiber itself, the miniaturization is easy, and the manufacturing cost can be made inexpensive.

Further, since the direction of the end face can be mechanically rotation-positioned by pushing the flat plate to the plane structure, meshing the key structure with the concave structure or observing the plane structure and the like, it becomes possible to rotation-position the end face easily and at a high speed. For this reason, it becomes possible to produce the optical device inexpensively and in large quantity.

Further, the plane structure and the like can be produced or attached with a high positional precision with respect to the direction of the end face without the optical fiber being rotated when working. For this reason, the reference plane for positioning can be produced easily, inexpensively and with a high precision. Further, since the optical fiber can be also worked while being held intact by the holding structure, the direction of the end face can be discriminated by the holding structure even if the optical fiber is taken out from the working jig, so that the simple positioning becomes possible.

Further, by means of forming the two end faces by cutting one optical fiber, the production is made with a high speed and in large quantity and, additionally, the axis displacement of the core owing to the individual difference of the optical fiber is eliminated and a high connecting efficiency can be realized.

What is claimed is:

1. An optical fiber having an end face formed with a slanted angle with respect to a plane perpendicular to a center line of a core, wherein a plane structure having at least one plane is formed in the optical fiber itself.

2. An optical fiber having an end face formed with a slanted angle with respect to a plane perpendicular to a center line of a core, wherein a concave structure is formed in the optical fiber itself.

3. An optical fiber according to claim 1, wherein the plane structure is constituted by at least one plane including a straight line approximately parallel to the center axis of the core of the optical fiber.

4. An optical fiber according to claim 2, wherein the concave structure is constituted by at least one plane including a straight line approximately parallel to the center axis of the core of the optical fiber.

5. An optical fiber having an end face formed with a slanted angle with respect to a plane perpendicular to a center line of a core, wherein there is provided a holding structure fixed to the optical fiber or a coating covering the optical fiber and having a plane including a straight line approximately parallel to at least the center line of the core.

6. An optical fiber according to claim 1, wherein the plane of the plane structure is provided at a position becoming a predetermined direction with respect to a slant direction of the end face.

7. An optical fiber according to claim 2, wherein the plane of the concave structure is provided at a position becoming a predetermined direction with respect to a slant direction of the end face.

8. An optical fiber according to claim 5, wherein the plane of the holding structure is provided at a position becoming a predetermined direction with respect to a slant direction of the end face.

9. Two optical fibers according to claim 1, each of which has an end face formed with a slanted angle with respect to a plane perpendicular to a center line of a core, and in each of which there is formed the plane structure is attached,
wherein the two optical fibers are manufactured from one optical fiber in which a straight line parallel to the center axis of the core is supposed on an outside face, and the supposed straight line is disposed on an approximately one straight line in case where the end faces of the two optical fibers are parallel disposed while being mutually faced.

10. Two optical fibers according to claim 2, each of which has an end face formed with a slanted angle with respect to a plane perpendicular to a center line of a core, and in each of which there is formed the concave structure is attached,
wherein the two optical fibers are manufactured from one optical fiber in which a straight line parallel to the center axis of the core is supposed on an outside face, and the supposed straight line is disposed on an approximately one straight line in case where the end faces of the two optical fibers are parallel disposed while being mutually faced.

11. Two optical fibers according to claim 5, each of which has an end face formed with a slanted angle with respect to a plane perpendicular to a center line of a core, and in each of which there is formed to which the holding structure is attached,
wherein the two optical fibers are manufactured from one optical fiber in which a straight line parallel to the center axis of the core is supposed on an outside face, and the supposed straight line is disposed on an approximately one straight line in case where the end faces of the two optical fibers are parallel disposed while being mutually faced.

12. Two optical fibers according to claim 1, each of which has an end face formed with a slanted angle with respect to a plane perpendicular to a center line of a core, and in each of which there is formed the plane structure is attached,
wherein a position of the plane structure with respect to a direction of the slant of the end face observed from on an extension line of the center line of the core is disposed in an approximately 180 degrees point symmetry about the center axis of the core at the 1st optical fiber and the 2nd optical fiber.

13. Two optical fibers according to claim 2, each of which has an end face formed with a slanted angle with respect to a plane perpendicular to a center line of a core, and in each of which there is formed the concave structure is attached,
wherein a position of the concave structure with respect to a direction of the slant of the end face observed from on an extension line of the center line of the core is disposed in an approximately 180 degrees point symmetry about the center axis of the core at the 1st optical fiber and the 2nd optical fiber.

14. Two optical fibers according to claim 5, each of which has an end face formed with a slanted angle with respect to a plane perpendicular to a center line of a core, and in each of which there is formed to each of which the holding structure is attached,
wherein a position of the holding structure with respect to a direction of the slant of the end face observed from on an extension line of the center line of the core is disposed in an approximately 180 degrees point symmetry about the center axis of the core at the 1st optical fiber and the 2nd optical fiber.

15. A method of rotation-positioning an optical fiber having an end face formed with a slanted angle with respect to a plane perpendicular to a center line of a core, comprising the steps of:
forming a plane structure having at least one plane in the optical fiber itself; and
performing a rotation-positioning by pushing a plane of the plane structure to a plate held at a predetermined position.

16. A method of rotation-positioning an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core; and
performing a rotation-positioning by pushing a plane of the holding structure to a plate held at a predetermined position.

17. A method of rotation-positioning an optical fiber having an end face formed with a slanted angle with respect to a plane perpendicular to a center line of a core, comprising the steps of:
forming a concave structure in the optical fiber itself; and
performing a rotation-positioning by meshing the concave structure with a key structure held at a predetermined position.

18. A method of rotation-positioning an optical fiber having an end face formed with a slanted angle with respect to a plane perpendicular to a center line of a core, comprising the steps of:
forming a plane structure having at least one plane in the optical fiber itself; and
positioning the end face to a predetermined direction by means of controlling a rotation angle of the optical fiber about the center axis of the core by observing a position of the plane structure.

19. A method of rotation-positioning an optical fiber having an end face formed with a slanted angle with respect to a plane perpendicular to a center line of a core, comprising the steps of:
forming a concave structure in the optical fiber itself; and
positioning the end face to a predetermined direction by means of controlling a rotation angle of the optical fiber about the center axis of the core by observing a position of the concave structure.

20. A method of rotation-positioning an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core; and
positioning the end face to a predetermined direction by means of controlling a rotation angle of the optical fiber about the center axis of the core by observing a position of the holding structure.

21. A method of working an optical fiber having an end face formed with a slanted angle with respect to a plane perpendicular to a center line of a core, comprising the steps of:
forming a plane structure having at least one plane in the optical fiber itself;
fixing the optical fiber by a working jig;
working the end face of the optical fiber and the plane structure; and
detaching the optical fiber from the working jig.

22. A method of working an optical fiber having an end face formed with a slanted angle with respect to a plane perpendicular to a center line of a core, comprising the steps of:
forming a concave structure in the optical fiber itself;
fixing the optical fiber by a working jig;
working the end face of the optical fiber and the concave structure; and
detaching the optical fiber from the working jig.

23. A method of working an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core;
attaching the holding structure to the optical fiber or a coating covering the optical fiber;
fixing the optical fiber to a working jig together with the holding structure;
working the end face of the optical fiber; and
detaching only the working jig.

24. A method of working an optical fiber having an end face formed with a slanted angle with respect to a plane perpendicular to a center line of a core, comprising the steps of:
forming a concave structure in the optical fiber itself;
working a groove shape to the optical fiber approximately parallel to the core; and
cutting the groove shape portion of the optical fiber with a predetermined angle with respect to a plane perpendicular to the center axis of the core.

25. A method of working an optical fiber having an end face formed with a slanted angle with respect to a plane perpendicular to a center line of a core, comprising the steps of:
forming a plane structure having at least one plane in the optical fiber itself; and
cutting the plane structure portion in a predetermined direction and with a predetermined angle.

26. A method of working an optical fiber having an end face formed with a slanted angle with respect to a plane perpendicular to a center line of a core, comprising the steps of:
forming a plane structure having at least one plane in the optical fiber itself;
cutting the plane structure portion; and
polishing the end face in a predetermined direction with a predetermined angle.

27. A method of working an optical fiber having an end face formed with a slanted angle with respect to a plane perpendicular to a center line of a core, comprising the steps of:
forming a concave structure in the optical fiber itself; and
cutting the concave structure portion in a predetermined direction and with a predetermined angle.

28. A method of working an optical fiber having an end face formed with a slanted angle with respect to a plane perpendicular to a center line of a core, comprising the steps of:
forming a concave structure in the optical fiber itself;
cutting the concave structure portion; and
polishing the end face in a predetermined direction with a predetermined angle.

29. A method of working an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core;
attaching two holding structures to the optical fiber; and
cutting between the two holding structures in a predetermined direction and with a predetermined angle.

30. A method of working an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core;
attaching two holding structures to the optical fiber;
cutting between the two holding structures; and
polishing the end face in a predetermined direction with a predetermined angle.

31. A method of working an optical fiber having an end face formed with a slanted angle with respect to a plane perpendicular to a center line of a core, comprising the steps of:
forming a plane structure having at least one plane in the optical fiber itself;
performing a rotation-positioning by pushing a plate of the plane structure preliminarily formed to a plane structure held at a predetermined position; and
cutting the end face in a predetermined slant direction with respect to a positioned rotation position of the optical fiber and with a predetermined angle with respect to a plane perpendicular to the center axis of the core.

32. A method of working an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core;
performing a rotation-positioning by pushing a plate of the holding structure preliminarily formed to a plane structure held at a predetermined position; and
cutting the end face in a predetermined slant direction with respect to a positioned rotation position of the optical fiber and with a predetermined angle with respect to a plane perpendicular to the center axis of the core.

33. A method of working an optical fiber having an end face formed with a slanted angle with respect to a plane perpendicular to a center line of a core, comprising the steps of:
forming a concave structure in the optical fiber itself;
performing a rotation-positioning by meshing the concave structure preliminarily formed with a key structure held in a predetermined position; and
cutting the end face in a predetermined slant direction with respect to a positioned rotation position of the optical fiber and with a predetermined angle with respect to a plane perpendicular to the center axis of the core.

34. A method of working an optical fiber having an end face formed with a slanted angle with respect to a plane perpendicular to a center line of a core, comprising the steps of:
forming a plane structure having at least one plane in the optical fiber itself;
controlling a rotation angle of the optical fiber about the center axis of the core by observing a position of the plane structure preliminarily formed;
rotation-positioning the end face in a predetermined direction; and
cutting the end face in a predetermined slant direction with respect to a positioned rotation position of the optical fiber and with a predetermined angle with respect to a plane perpendicular to the center axis of the core.

35. A method of working an optical fiber having an end face formed with a slanted angle with respect to a plane perpendicular to a center line of a core, comprising the steps of:
forming a concave structure in the optical fiber itself;
controlling a rotation angle of the optical fiber about the center axis of the core by observing a position of the concave structure preliminarily formed;
rotation-positioning the end face in a predetermined direction; and
cutting the end face in a predetermined slant direction with respect to a positioned rotation position of the optical fiber and with a predetermined angle with respect to a plane perpendicular to the center axis of the core.

36. A method of working an optical fiber having an end face formed with a slanted angle with respect to a plane perpendicular to a center line of a core, comprising the steps of:
providing a holding structure fixed to the optical fiber or a coating covering the optical fiber and having a plane including a straight line approximately parallel to at least the center line of the core;
controlling a rotation angle of the optical fiber about the center axis of the core by observing a position of the holding structure preliminarily formed;
rotation-positioning the end face in a predetermined direction; and
cutting the end face in a predetermined slant direction with respect to a positioned rotation position of the optical fiber and with a predetermined angle with respect to a plane perpendicular to the center axis of the core.
